(19) United States
(12) Patent Application Publication
(10) Pub. No.: US 2024/0410767 A1
(43) Pub. Date: Dec. 12, 2024

(54) FORCE SENSOR AND METHOD FOR MANUFACTURING FORCE SENSOR

(71) Applicant: Alps Alpine Co., Ltd., Tokyo (JP)

(72) Inventors: Hisayuki YAZAWA, Niigata-ken (JP); Daisuke TSUCHIYA, Niigata-ken (JP); Hisanobu OKAWA, Niigata-ken (JP); Ayako OTSUKA, Niigata-ken (JP); Masayuki OBANA, Niigata-ken (JP)

(21) Appl. No.: 18/637,882

(22) Filed: Apr. 17, 2024

(30) Foreign Application Priority Data
Jun. 6, 2023 (JP) 2023-093505

(51) Int. Cl. G01L 1/16; B29C 45/14; G01L 1/22

(52) U.S. Cl. CPC G01L 1/16; G01L 1/2287; B29C 45/14639

(57) ABSTRACT

A force sensor includes a pressure transmission member having, at an end on one side in a first direction, a pressure receiving portion that receives a force to be detected and a sensor board disposed on the other side of the pressure transmission member in the first direction and having rigidity higher than the pressure transmission member. The sensor board includes a strain gauge element on a side facing the pressure transmission member. The pressure transmission member has a first region having a relatively low rigidity and a second region adjacent to the first region as viewed in the first direction and having a relatively high rigidity. The second region has a contact portion in contact with the sensor board. The strain gauge element is located in the vicinity of a boundary of the first region with the second region.

### CLAIM OF PRIORITY

This application claims benefit of Japanese Patent Application No. 2023-093505 filed on Jun. 6, 2023, which is hereby incorporated by reference.

### BACKGROUND OF THE INVENTION

### 1. Field of the Invention

The present invention relates to a force sensor and a method for manufacturing the force sensor.

### 2. Description of the Related Art

International Publication No. 2011/078043 discloses a force sensor and a method for manufacturing the force sensor capable of reducing substrate distortion due to residual stress after a substrate is bonded and improving yield. In this force sensor, a displacement portion is displaced when the displacement portion receives an external load via a pressure receiving portion. A sensor board including a plurality of piezoresistive elements whose electrical resistances vary in accordance with the amount of displacement and a base substrate that supports the sensor board are provided with a support portion that displaceably supports the displacement portion and a plurality of electrical connection portions that connect the plurality of piezoresistive elements, respectively. The support portions and the plurality of electrical connection portions are joined.

International Publication No. 2016/114248 discloses a force sensor unit that has a simple structure and, thus, can be easily assembled and is easily miniaturized. This force sensor unit has a cylinder, a substrate that seals one end of the cylinder, a force sensor supported on a substrate, and a force transmission mechanism consisting of a contact member, a coil spring, and a member to be operated, which are arranged inside the interior space of the cylinder and transmit force to the force sensor.

In a force sensor, it is desirable to effectively flex the area where the strain gauge element is formed, while preventing the pressure receiving portion from being destroyed by overload due to impact.

### SUMMARY OF THE INVENTION

The present invention provides a force sensor with excellent load bearing property and strain detection characteristics and a method for manufacturing a force sensor.

According to an aspect of the present invention, a force sensor includes a pressure transmission member having, at an end on one side in a first direction, a pressure receiving portion configured to receive a force to be detected and a sensor board disposed on the other side of the pressure transmission member in the first direction and having rigidity higher than the pressure transmission member. The sensor board includes a strain gauge element on a side facing the pressure transmission member. The pressure transmission member has a first region having a relatively low rigidity and a second region adjacent to the first region as viewed in the first direction and having a relatively high rigidity. The second region has a contact portion in contact with the sensor board. The strain gauge element is located in the vicinity of a boundary of the first region with the second region.

According to the configuration, the first region has a lower rigidity than the other region, so that the first region is preferentially compressed when an external force is applied to the pressure receiving portion. The preferential compression of the first region increases the load bearing property. In addition, due to the compression, a member that constitutes the second region adjacent to the first region is deformed. The deformation causes a stress concentration on the contact portion in contact with the sensor board in the second region, resulting in efficient strain detection by the strain gauge element.

In the above-described force sensor, the first region may be disposed in contact with the sensor board. In the case of the first region in contact with the sensor board, tensile deformation is highly likely to occur in the sensor board due to the stress concentration on the contact portion of the second region, since a member that constitutes the first region, which has relatively low rigidity, is in contact with the sensor board. As a result, the detection sensitivity of the strain gauge element is increased, as compared with the case where a member that constitutes the second region is in contact with the portion where the tensile deformation occurs.

In the above-described force sensor, at least part of the pressure receiving portion may overlap the first region and the sensor board as viewed in the first direction. As a result, since the first region and the sensor board are disposed along the first direction from the center of application of an external force applied to the pressure receiving portion (the center of gravity of the contact area between the member to which the external force is applied and the pressure receiving portion), compression deformation of the member that constitutes the first region easily occurs. This configuration facilitates deformation of the second region and allows the stress strain based on the external force to be efficiently applied to the strain gauge element.

The above-described force sensor may further include a pressure receiving member having a higher rigidity than the second region on the one side of the pressure transmission member in the first direction so as to have a portion that overlaps the pressure receiving portion as viewed in the first direction. This configuration effectively applies external force to the pressure receiving portion and prevents damage to the pressure receiving portion.

In the above-described force sensor, the pressure receiving portion may have a protruding portion that protrudes toward the one side in the first direction. Due to the configuration, the protruding portion is subjected to the external force and, thus, the external force is effectively transmitted to the pressure receiving portion.

In the above-described force sensor, the first region may be formed of a material that differs from a material used for the second region. This configuration allows the balance of rigidity between the first region and the second region to be determined by selection of the materials.

In the above-described force sensor, at least part of the first region may be formed by a space. Thus, the rigidity of the first region is determined by the space that is part of the first region.

In the above-described force sensor, the strain gauge element may include at least one piezoresistive element. This configuration allows strain detection by the piezoresistive effect.

In the above-described force sensor, the strain gauge element may be located in the sensor board so as to face the vicinity of the boundary. As a result, stress strain due to the external force is efficiently transmitted from the vicinity of the boundary between the first region and the second region to the strain gauge element disposed in the sensor board at a position facing the vicinity of the boundary.

In the above-described force sensor, four piezoresistive elements may be provided around the pressure receiving portion as viewed in the first direction, and a difference between two midpoint potentials in a full-bridge circuit including the four piezoresistive elements may be an output value. This configuration allows strain detection to be performed by the full-bridge circuit including four piezoresistive elements.

According to an aspect of the present invention, a method for manufacturing a force sensor is provided. The force sensor includes a pressure transmission member having, at an end on one side in a first direction, a pressure receiving portion configured to receive a force to be detected and a sensor board disposed on the other side of the pressure transmission member in the first direction and having a rigidity higher than a rigidity of the pressure transmission member. The sensor board includes a strain gauge element on a side facing the pressure transmission member. The method includes attaching a first member to a first surface of the sensor board having the strain gauge element provided on the first surface and placing, on a first surface side of the sensor board, a second member formed of a material containing a resin and having a rigidity higher than a rigidity of the first member and lower than a rigidity of the sensor board so as to cover the first member. In the attaching, the first member is attached to the first surface so that the strain gauge element has an overlapping portion that overlaps a vicinity of an outer edge of the first member as viewed in the first direction. Through the attaching and placing, the pressure transmission member is formed that has a first region formed by the first member and a second region that is formed by the second member and that is adjacent to the first region as viewed in the first direction.

According to an aspect of the present invention, a method for manufacturing a force sensor is provided. The force sensor includes a pressure transmission member having, at an end on one side in a first direction, a pressure receiving portion configured to receive a force to be detected and a sensor board disposed on the other side of the pressure transmission member in the first direction and having a rigidity higher than a rigidity of the pressure transmission member, where the sensor board includes a strain gauge element on a side facing the pressure transmission member. The method includes placing, on a first surface side of the sensor board on which the strain gauge element is provided, a second member formed of a material containing a resin and having a rigidity lower than a rigidity of the sensor board. In the placing, the pressure transmission member is formed that has a first region including the second member and a void part and a second region that is formed by the second member and that is adjacent to the first region and, in the placing, the second member is placed so that the strain gauge element faces a vicinity of a boundary of the first region with the second region.

In the placing of the above-described method for manufacturing a force sensor, the second member may be placed by a molding process.

In the placing of the above-described method for manufacturing a force sensor, a pressure receiving member having a rigidity higher than the rigidity of the second region may be placed separated from the first surface so as to face each other, and the material containing a resin may be insert molded.

The above-described method for manufacturing a force sensor may further include attaching a pressure receiving member having a rigidity higher than the rigidity of the second region such that the pressure transmission member has, on the one side in the first direction, a portion that overlaps the pressure receiving portion as viewed in the first direction.

### BRIEF DESCRIPTION OF THE DRAWINGS

FIG. 1 is an external perspective view of an example of a force sensor according to the present embodiment;

FIG. 2 is an exploded perspective view of the example of a force sensor according to the present embodiment;

FIG. 3 is a cross-sectional view of the example of a force sensor according to the present embodiment;

FIG. 4 is a plan view of an example of arrangement of strain gauge elements;

FIG. 5 is a perspective view of an example of the configuration of a sensor board;

FIG. 6 is a plan view of the example of the configuration of the sensor board;

FIG. 7 is a schematic cross-sectional view illustrating the relationship between the sensor board and a pressure transmission member;

FIG. 8 is a stress distribution diagram when a load is applied to the force sensor according to the present embodiment;

FIG. 9 is a stress distribution diagram when a load is applied to the force sensor according to the present embodiment;

FIG. 10 is a stress distribution diagram when a load is applied to the force sensor according to the present embodiment;

FIG. 11 is a perspective view of another example of a protruding portion;

FIG. 12 is a cross-sectional view of the example of the protruding portion;

FIG. 13 is a stress distribution diagram when a load is applied to a force sensor having the example of a protruding portion;

FIG. 14 is a stress distribution diagram when a load is applied to a force sensor having another example of a protruding portion;

FIG. 15 is a stress distribution diagram when a load is applied to a force sensor having another example of a protruding portion;

FIG. 16A is an XZ cross-sectional view of the configuration of a force sensor according to a comparative example;

FIG. 16B is an XY cross-sectional view of the configuration of the force sensor according to the comparative example;

FIG. 17 is a stress distribution diagram when a load is applied to the force sensor according to the comparative example;

FIGS. 18A through 18C are schematic cross-sectional views illustrating a method (first method) for manufacturing a force sensor according to the present embodiment;

FIGS. 19A through 19C are schematic cross-sectional views illustrating a method (second method) for manufacturing a force sensor according to the present embodiment;

FIG. 20A is a plan view of a first force sensor;

FIG. 20B is a plan view of a second force sensor;

FIG. 20C is a plan view of a third force sensor;

FIG. 20D is a plan view of a fourth force sensor;

FIG. 20E is a plan view of a fifth force sensor;

FIG. 20F is a plan view of a sixth force sensor; and

FIG. 21 is a graph of the output values of the first to sixth force sensors and a comparative force sensor.

### DESCRIPTION OF THE PREFERRED EMBODIMENTS

Embodiments of the present invention are described in detail below with reference to the accompanying drawings. In the following description, identical members are identified by the same reference numerals, and description of an already-described member is omitted as appropriate.

### Overview of Force Sensor

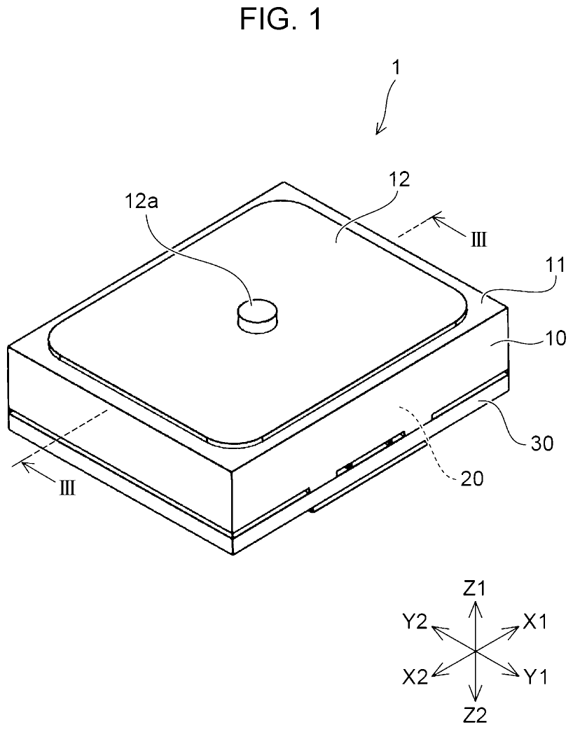

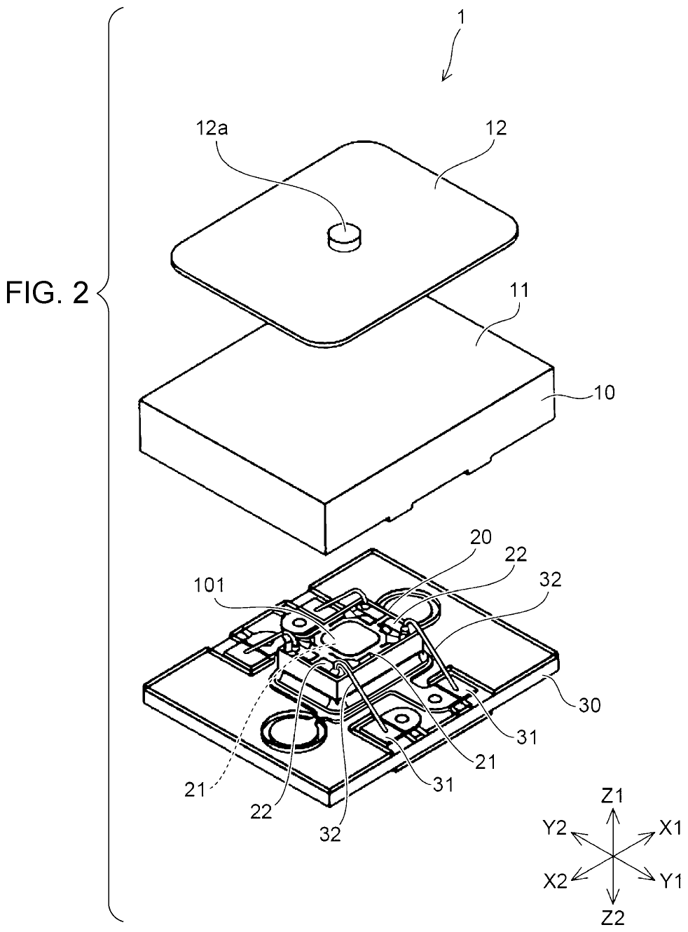

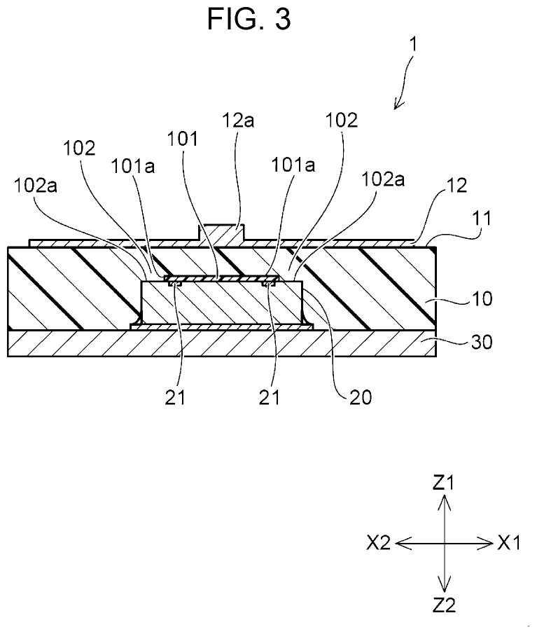

FIG. 1 is an external perspective view of an example of a force sensor according to the present embodiment. FIG. 2 is an exploded perspective view of the example of a force sensor according to the present embodiment. FIG. 3 is a cross-sectional view of the example of a force sensor according to the present embodiment and is a cross-sectional view taken along a line III-III of FIG. 1.

According to the present embodiment, a force sensor 1 is a device that receives an external load and outputs a signal corresponding to the load. The force sensor 1 includes a pressure transmission member 10 that has a pressure receiving portion 11 at an end on one side in a first direction to receive a force to be detected and a sensor board 20 that is located on the other side of the pressure transmission member 10 in the first direction and that has a higher rigidity than the pressure transmission member 10. According to the present embodiment, the term “first direction” refers to a Z1-Z2 direction, the term “one side in the first direction” refers to a Z1 side, and the term “the other side in the first direction” refers a Z2 side. Accordingly, the pressure receiving portion 11 is provided on the Z1 side of the pressure transmission member 10, and the sensor board 20 is disposed on the Z2 side of the pressure transmission member 10.

The pressure transmission member 10 is provided to cover the periphery and the Z1 side of the sensor board 20. The pressure transmission member 10 is made of a material containing a resin material and has a first region 101 with relatively low rigidity and a second region 102 with relatively high rigidity adjacent to the first region 101 in the Z1-Z2 direction. The second region 102 has a contact portion 102a that is in contact with the sensor board 20. The second region 102 is made of silica-filled epoxy, for example. The first region 101 is made of, for example, a resist resin which has a lower Young's modulus than the material of the second region 102.

A pressure receiving member 12 may be further provided on the Z1 side of the pressure transmission member 10 so as to have a portion that overlaps the pressure receiving portion 11 as viewed in the Z1-Z2 direction. The pressure receiving member 12 may be provided on the Z1 side surface of the pressure transmission member 10 or may be buried on the Z1 side of the pressure transmission member 10.

It is desirable that the pressure receiving member 12 be a metal in terms of the rigidity and elasticity (shape recovery after the pressure is released). The pressure receiving member 12 is formed of, for example, a material that has higher rigidity than the pressure transmission member 10 and preferably a material (such as stainless steel) that has higher rigidity than the sensor board 20. The pressure receiving member 12 can effectively apply external force to the pressure receiving portion 11 and can also effectively protect the pressure receiving portion 11 from damage more.

A protruding portion 12a that protrudes toward the Z1 side may be provided in the substantial center of the pressure receiving member 12. If the pressure receiving member 12 is not provided, the pressure receiving portion 11 of the pressure transmission member 10 may be provided with the protruding portion 12a. When the protruding portion 12a is provided, the protruding portion 12a is subjected to external force and can effectively transmit the external force to the pressure receiving portion 11.

The sensor board 20 is mounted on a wiring substrate 30. The wiring substrate 30 includes pads 31, and pads 22 of the sensor board 20 and the pads 31 of the wiring substrate 30 are connected by bonding wires 32. The pressure transmission member 10 is provided on the side of the wiring substrate 30 having the sensor board 20 mounted thereon (the Z1 side) and is formed to cover the bonding wires 32 as well as the sensor board 20.

The sensor board 20 is formed of a material having a higher rigidity than the pressure transmission member 10. For example, the sensor board 20 is formed of silicon or a silicon compound. The sensor board 20 includes a strain gauge element 21 on the side facing the pressure transmission member 10. The strain gauge element 21 is, for example, a piezoresistive element. The strain gauge element 21 may be provided on a surface of the sensor board 20 facing the pressure transmission member 10 or may be buried inwardly from the surface.

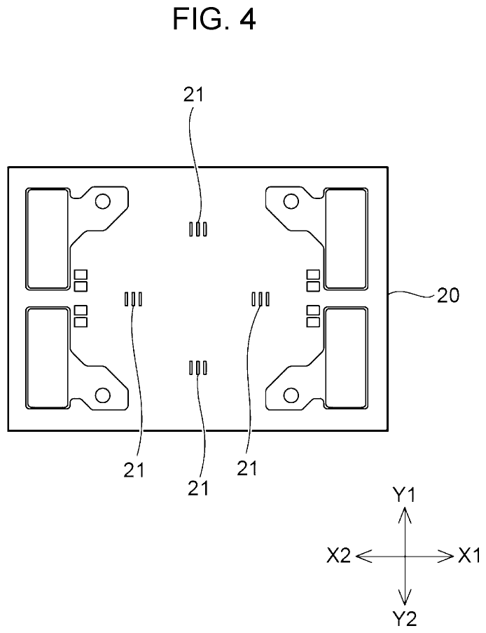

FIG. 4 is a plan view of an example of the arrangement of strain gauge elements 21. The strain gauge elements 21 are formed on the Z1 side surface or portion of the sensor board 20. The strain gauge element 21 is an element that electrically detects the amount of displacement. A plurality (for example, four) strain gauge elements 21 are provided on the sensor board 20. The plurality of strain gauge elements 21 are arranged along the Z1 side surface of the sensor board 20 such that adjacent elements have a phase difference of 90° (the positional relationship such that adjacent elements are orthogonal to each other). When the sensor board 20 is displaced by the load received by the pressure receiving portion 11, the electrical resistances of the plurality of strain gauge elements 21 change in accordance with the amount of displacement. Thus, the midpoint potential of the full-bridge circuit formed by the plurality of strain gauge elements 21 changes, and the midpoint potential is the output of the sensor.

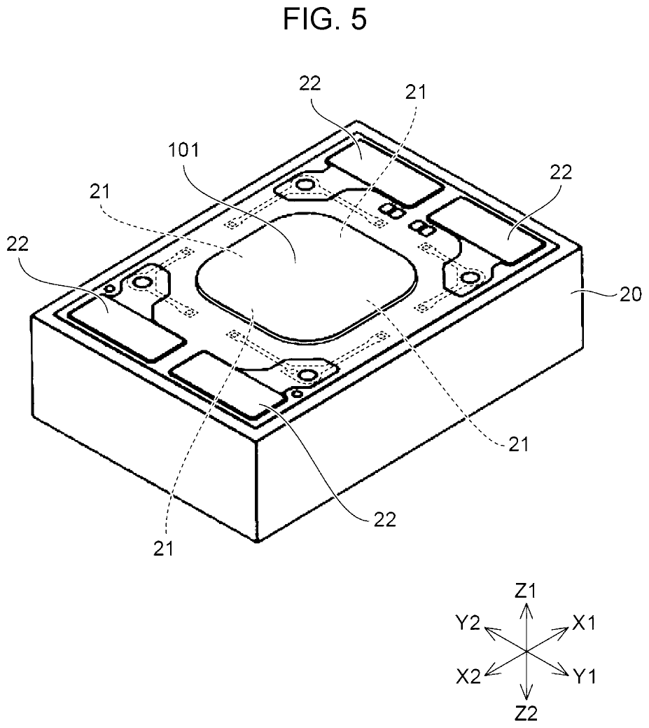

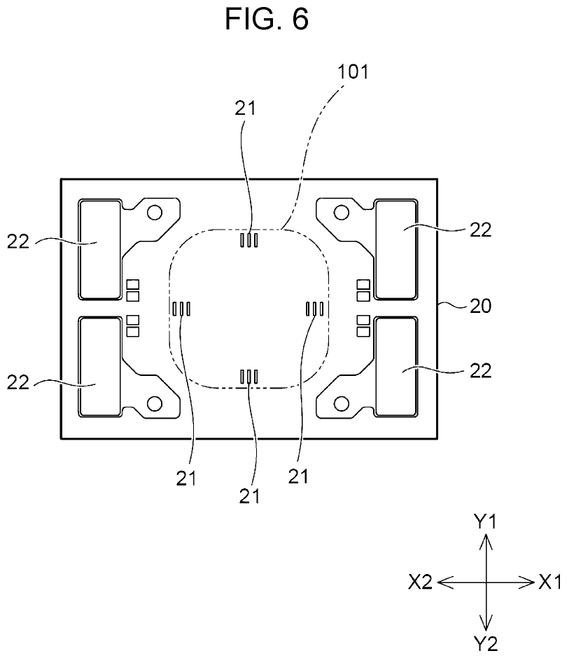

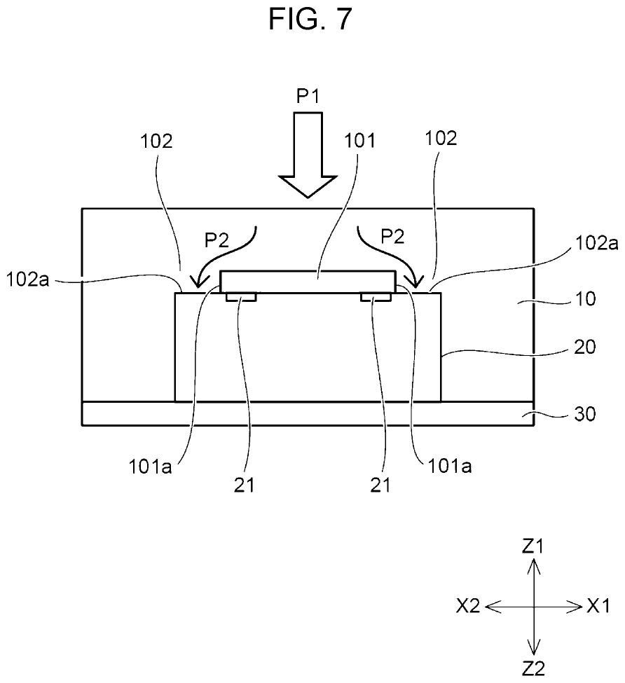

FIG. 5 is a perspective view of an example of the configuration of the sensor board 20. FIG. 6 is a plan view of the example of configuration of the sensor board 20. For convenience of description, FIGS. 5 and 6 illustrate the first region 101 of the pressure transmission member 10 provided on the Z1 side of the sensor board 20. In FIG. 6, the first region 101 is denoted by a dash-double-dot line. FIG. 7 is a schematic cross-sectional view illustrating the relationship between the sensor board 20 and the pressure transmission member 10.

The strain gauge element 21 provided on the sensor board 20 is located facing the vicinity of the boundary of the first region 101 of the pressure transmission member 10 with the second region 102. For example, as viewed in the Z1-Z2 direction, the first region 101 is provided so as to have a shape of a substantial quadrangle. Each of portions of a boundary 101a of the first region 101 with the second region 102 that corresponds to one of the sides of the substantial quadrangle is located in the vicinity of one of the four strain gauge elements 21 (for example, on slightly outside of the strain gauge element 21). Each of the portions of the boundary 101a of the first region 101 that corresponds to one of the sides of the substantial quadrangle may be located on slightly inside of one of the four strain gauge elements 21.

In the force sensor 1, the rigidity decreases in the order: the sensor board 20, the second region 102, and then the first region 101. Since the rigidity of the first region 101 is lower than that of the second region 102, the first region 101 is preferentially compressed when an external force P1 is applied to the pressure receiving portion 11 as illustrated in FIG. 7. Due to the compression, a member that constitutes the second region 102 adjacent to the first region 101 is deformed. The deformation causes a stress concentration (refer to arrow P2) on the contact portion 102a that is in contact with the sensor board 20 in the second region 102, resulting in a high contact pressure on the sensor board 20.

The sensor board 20 located around the contact portion 102a where the stress concentration occurs is easily subjected to tensile deformation. Therefore, the strain gauge element 21 is disposed in the sensor board 20 so as to have a portion facing the vicinity of the boundary of the first region 101 with the second region 102 as viewed in the Z1-Z2 direction. Thus, the strain gauge element 21 can efficiently detect the external force P1 received by the pressure receiving portion 11. That is, the first region 101 functions as a stress guiding portion that guides the stress generated inside of the pressure transmission member 10 by the external force P1 applied to the pressure receiving portion 11 to the periphery of the strain gauge element 21.

As described above, since the stress distribution of the pressure transmission member 10 is controlled by the first region 101, there is no need to create an easily deformable portion, such as a diaphragm, in the sensor board 20. As a result, the structure and the manufacturing method of the sensor board 20 can be simplified (for example, the need for microelectromechanical system (MEMS) processing is eliminated). In addition, since stress can be guided to any position of the sensor board 20, the degree of freedom in designing the force sensor 1 (for example, the layout of the strain gauge elements 21) can be increased. For example, if anisotropy is given to the compression of the first region 101 based on the application of external force, the stress propagating to the sensor board 20 can be guided in a specific direction.

The first region 101 may be a cavity. The first region 101 may or may not be in contact with the sensor board 20. In the case of the first region 101 in contact with the sensor board 20, tensile deformation is highly likely to occur in the sensor board 20 due to the stress concentration on the contact portion 102a of the second region 102, since a member that constitutes the first region 101, which has relatively low rigidity, is in contact with the sensor board 20. As a result, the detection sensitivity of the strain gauge element 21 is increased, as compared with the case where the member that constitutes the first region 101 is not in contact with the portion where the tensile deformation occurs.

In addition, the configuration is such that, as viewed in the Z1-Z2 direction, at least part of the pressure receiving portion 11 overlaps the first region 101 and the sensor board 20. As a result, since the first region 101 and the sensor board 20 are disposed along the Z1-Z2 direction from the center of application of the external force P1 applied to the pressure receiving portion 11 (the center of gravity of the contact area between the member to which the external force P1 is applied and the pressure receiving portion 11), compression deformation of the member that constitutes the first region 101 easily occurs. This configuration facilitates deformation of the second region 102 and allows the stress strain based on the external force P1 to be efficiently applied to the strain gauge element 21.

By selecting different materials for the first region 101 and the second region 102, the balance of rigidity between the first region 101 and the second region 102 can be determined by the selected materials and, thus, the stress guiding function by the first region 101 and the stress concentration function by the second region 102 can be determined as desired.

### <Stress Distribution of Application of Load>

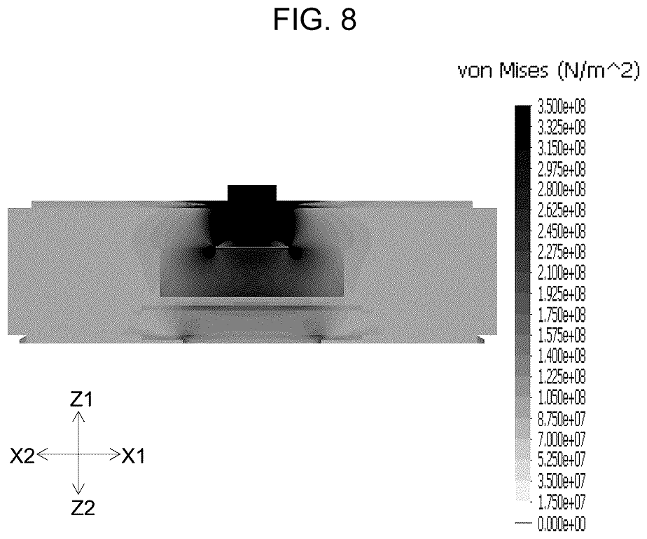

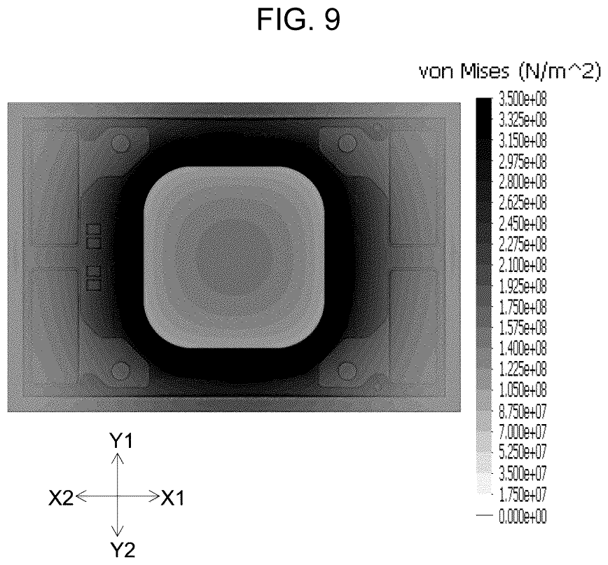

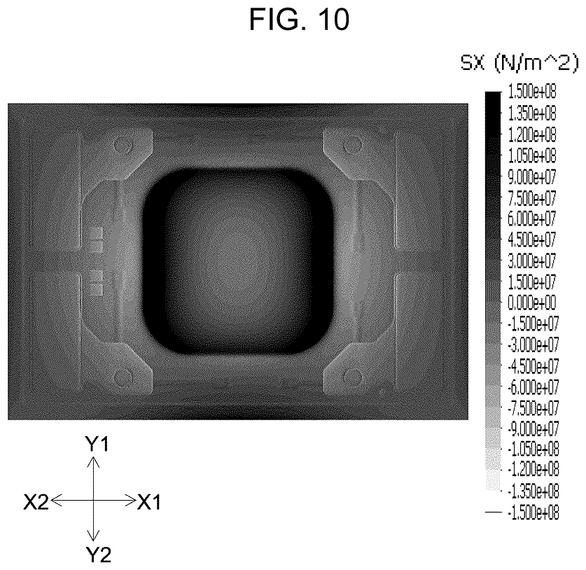

FIGS. 8 to 10 are stress distribution diagrams when a load is applied to the force sensor 1 according to the present embodiment. FIG. 8 illustrates the cross-sectional stress distribution when a load is applied to the force sensor 1 according to the present embodiment. FIG. 9 illustrates the stress distribution on the Z1 side surface of the sensor board 20 when a load is applied to the force sensor 1 according to the present embodiment. FIG. 10 illustrates the stress distribution in the X1-X2 direction at a depth (a position in the Z1-Z2 direction) where the strain gauge element 21 of the sensor board 20 is located when a load is applied to the force sensor 1 according to the present embodiment.

In the force sensor 1 according to the present embodiment, as viewed in the Z1-Z2 direction, the protruding portion 12a that is narrower than the first region 101 is disposed. When a load is applied to the protruding portion 12a and, thus, the stress is transmitted from the pressure receiving member 12 having the protruding portion 12a to the pressure transmission member 10, the first region 101 is compressed first and then the second region 102 is compressed. This indicates that the stress transmitted to the pressure transmission member 10 is concentrated on the boundary between the first region 101 and the second region 102. Therefore, by providing the strain gauge element 21 on the sensor board 20 in the vicinity of the boundary between the first region 101 and the second region 102, the load received by the pressure receiving portion 11 can be efficiently detected by the strain gauge element 21.

### Other Examples of Protruding Portion

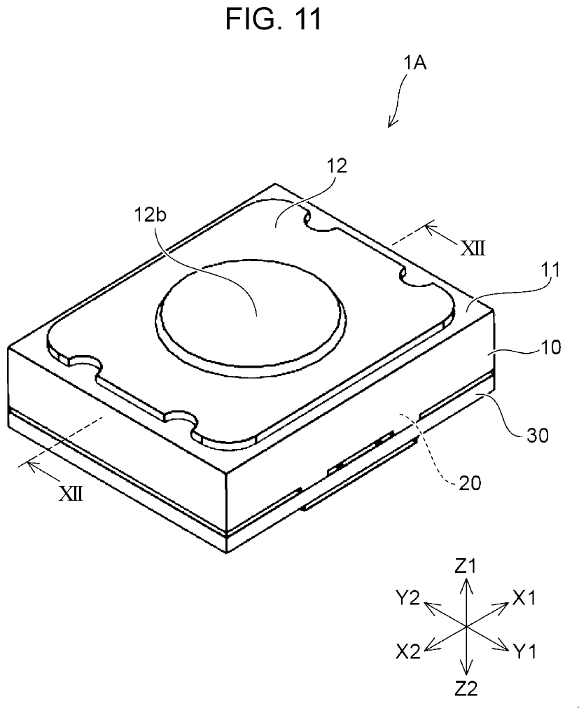

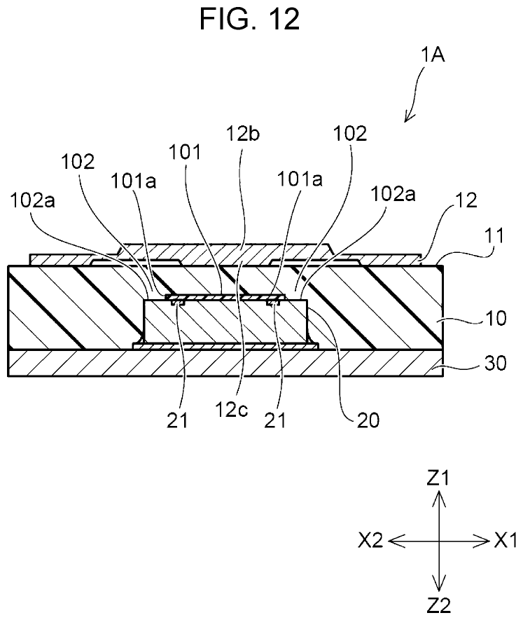

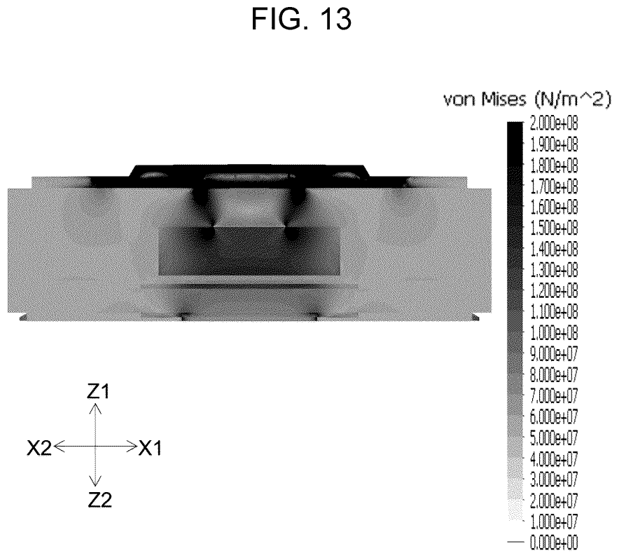

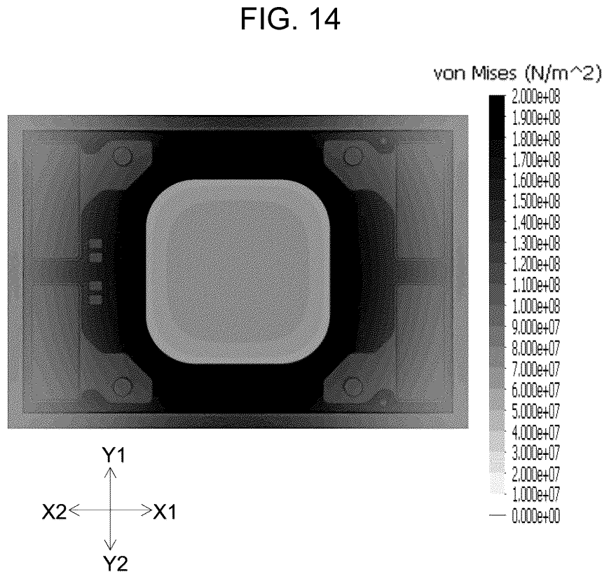

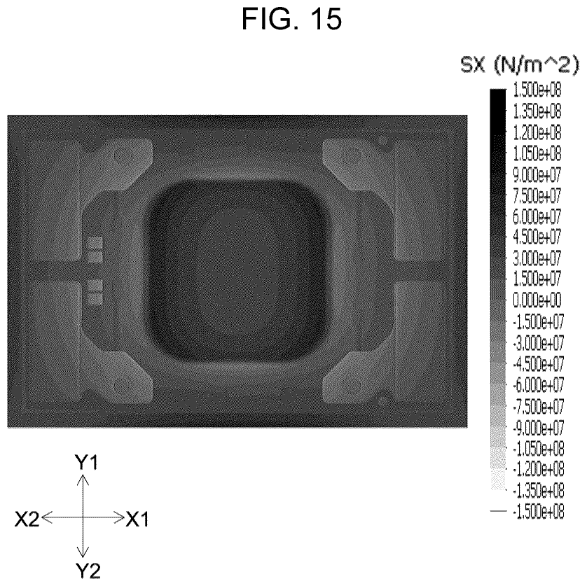

FIG. 11 is a perspective view of a force sensor including a protruding portion according to another example. FIG. 12 is a cross-sectional view of the force sensor including the protruding portion according to the example. FIGS. 13 to 15 are stress distribution diagrams when a load is applied to the force sensor including the protruding portion according to the example. FIG. 12 is a cross-sectional view taken along line XII-XII of FIG. 11. FIG. 13 illustrates a cross-sectional stress distribution when a load is applied to a force sensor 1A including a protruding portion (another protruding portion 12b) according to the example. FIG. 14 illustrates the stress distribution on the Z1 side surface of the sensor board 20 when a load is applied to the force sensor 1A including the protruding portion 12b. FIG. 15 illustrates the stress distribution in the X1-X2 direction at a depth (a position in the Z1-Z2 direction) where the strain gauge element 21 of the sensor board 20 is located when a load is applied to the force sensor 1A including the protruding portion 12b.

As illustrated in FIGS. 11 and 12, in the force sensor 1A, the protruding portion 12b is provided so as to overlap the first region 101 and has a larger size than the first region 101, as viewed in the Z1-Z2 direction. The protruding portion 12b has a larger size than the protruding portion 12a illustrated in FIG. 8. A counter protruding portion 12c may be provided on the side of the pressure receiving member 12 remote from the protruding portion 12b. It is desirable that the counter protruding portion 12c be provided at a position overlapping the protruding portion 12b and have a smaller size than the protruding portion 12b as viewed in the Z1-Z2 direction.

If the protruding portion 12b is large, a member to be in contact with the protruding portion 12b can be in stable contact with the protruding portion 12b. By making the counter protruding portion 12c smaller than the protruding portion 12b, the load stably received by the larger protruding portion 12b can be concentrated on the counter protruding portion 12c and be given to the strain gauge element 21.

It can be seen that when a load is applied to the protruding portion 12b and, thus, stress is transmitted from the pressure receiving member 12 including the protruding portion 12b to the pressure transmission member 10, the stress is concentrated on the boundary between the first region 101 and the second region 102 more. Therefore, by providing a strain gauge element 21 on the sensor board 20 in the vicinity of the boundary between the first region 101 and the second region 102, the load received by the pressure receiving portion 11 can be efficiently detected by the strain gauge element 21.

### COMPARATIVE EXAMPLE

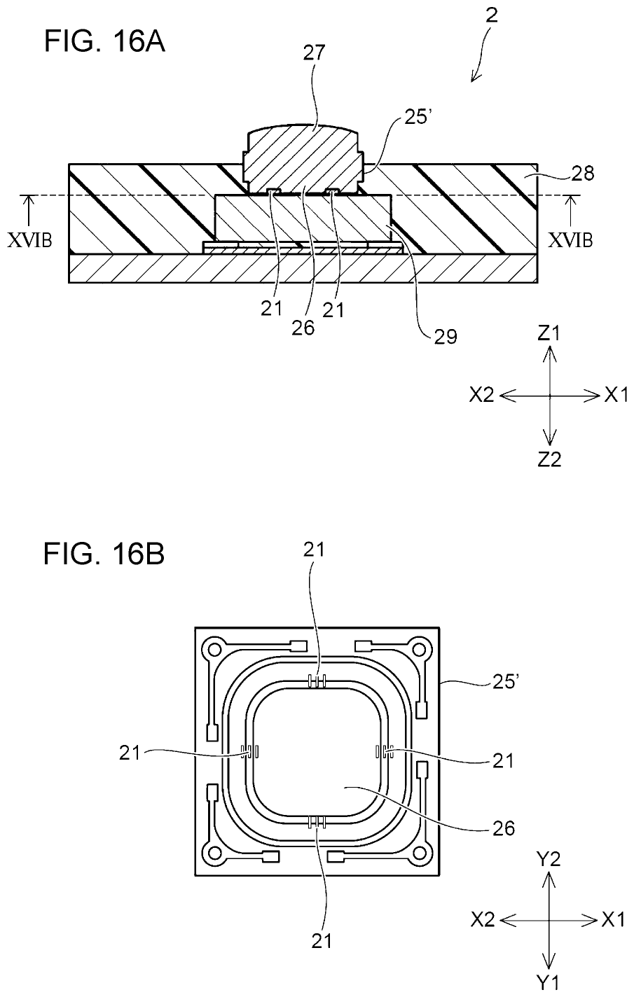

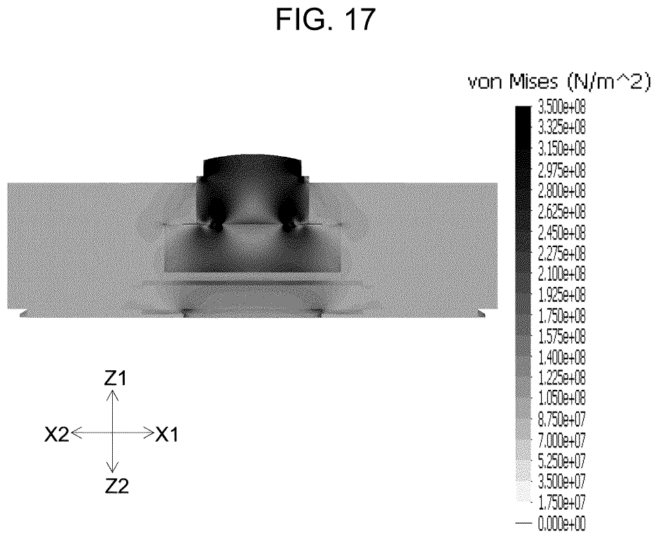

FIG. 16A is an XZ cross-sectional view illustrating an example of the configuration of a force sensor according to a comparative example. FIG. 16B is an XY cross-sectional view of the configuration of the force sensor according to the comparative example and is a cross-sectional view taken along line XVIB-XVIB of FIG. 16A. FIG. 17 is a stress distribution diagram when a load is applied to the force sensor according to the comparative example.

As illustrated in FIG. 16A, the force sensor according to the comparative example (a comparative force sensor 2) has a structure in which a sensor element 25′ produced by MEMS processing using single-crystal silicon is stacked on a sensor board 29. A displacement portion 26 and a strain gauge element 21 are formed on the Z2 side of the sensor element 25′. A pressure receiving portion 27 is provided on the Z1 side of the sensor element 25′. The sensor element 25′ is covered by a sealing resin 28, and part of the pressure receiving portion 27 protrudes from the Z1 side of the sealing resin 28. As illustrated in FIG. 16B, the displacement portion 26 consists of a diaphragm having a substantially square shape and is connected to the other portion of the sensor element 25′ by connecting portions provided at two locations in the X1-X2 direction and two locations in the Y1-Y2 direction. Each of the four connecting portions has a strain gauge element 21 provided therein.

When, as illustrated in FIG. 17, a load is applied to the pressure receiving portion 27 of the comparative force sensor 2, flexural deformation occurs in the sensor element 25′ due to the load and, thus, stress is transmitted to the sensor board 29 on the Z2 side. At this time, the position of the displacement portion 26, which consists of a diaphragm, changes relative to the connecting portion. The change is detected by the strain gauge element 21, and a signal is output. In the comparative force sensor 2, the pressure receiving portion 27 is formed of single-crystal silicon with low toughness together with the sensor element 25′. For this reason, when a heavy load (impact load) is applied to the comparative force sensor 2, the load is transmitted to the sensor board 29 through the members made of single-crystal silicon (the pressure receiving portion 27 and sensor element 25′). Therefore, the comparative force sensor 2 is easily affected by the load. For example, if an excessive load is applied, the pressure receiving portion 27 and sensor element 25′ may be highly likely to be damaged.

In contrast, in the force sensor 1 according to the present embodiment, the first region 101 is preferentially compressed by the load applied to the pressure receiving portion 11, and stress can be guided to the second region 102. Therefore, even if an impact load is applied, the stress can be guided to the second region 102 while being absorbed by the first region 101, resulting in high impact resistance. In addition, by providing the strain gauge element 21 on the sensor board 20 in the vicinity of the boundary between the first region 101 and the second region 102, the stress guided to the second region 102 can be effectively transmitted to the strain gauge element 21, which increases the detection sensitivity of the strain gauge element 21.

### <Method for Manufacturing Force Sensor>

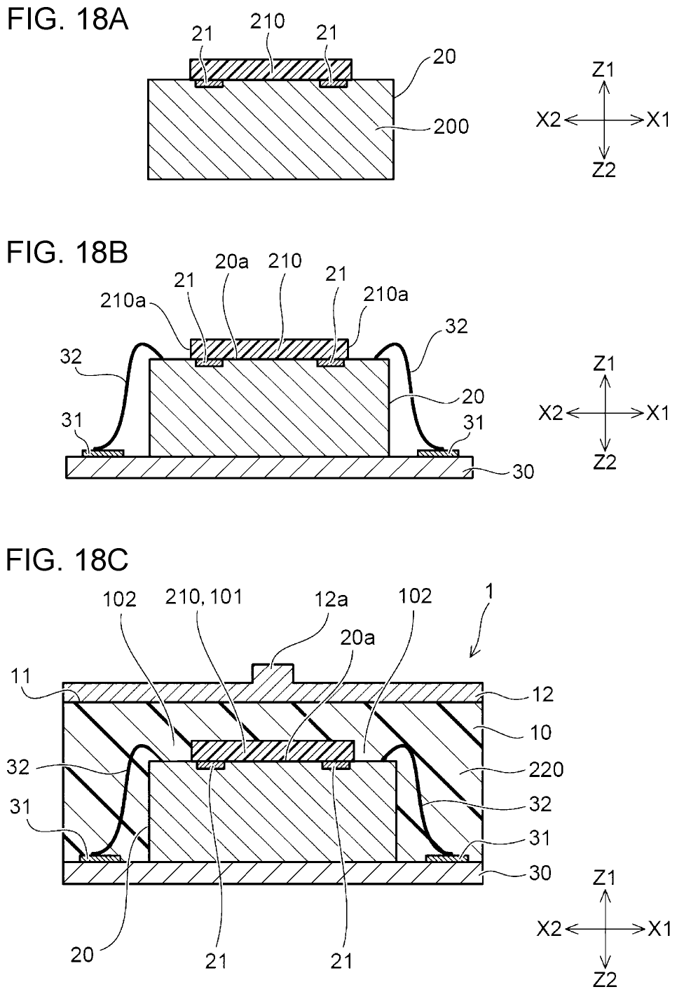

FIGS. 18A to 18C are schematic cross-sectional views illustrating a method (a first method) for manufacturing the force sensor according to the present embodiment. As illustrated in FIG. 18A, a sensor board 20 is first formed. For example, a silicon substrate 200 is prepared, and the strain gauge element 21 is formed on the silicon substrate 200. The silicon substrate 200 also contains silicon compounds in addition to silicon. The strain gauge element 21 is, for example, a piezoresistive element. Subsequently, a first member 210 is attached to the surface of the silicon substrate 200 having the strain gauge element 21 thereon (an attaching step). For example, a cured material of photoresist is used for the first member 210. The first member 210 is provided to cover part of the surface of the silicon substrate 200 having the strain gauge element 21 thereon. The location of an edge 210a of the first member 210 is in the vicinity of the strain gauge element 21. As a result, the strain gauge element 21 has an overlapping portion that overlaps the vicinity of the outer edge of the first member 210. Thereafter, the strain gauge element 21 is formed, and the silicon substrate 200 is diced to a predetermined size to form the sensor board 20.

Subsequently, as illustrated in FIG. 18B, the sensor board 20 is mounted on the wiring substrate 30, and the bonding wire 32 is used to connect the sensor board 20 to the pad 31 on the wiring substrate 30.

Subsequently, as illustrated in FIG. 18C, a second member 220 is placed on the side adjacent to a first surface 20a of the sensor board 20 (a placing step). The second member 220 is formed to cover the sensor board 20 as well as the bonding wire 32 on the side (Z1 side) where the sensor board 20 is mounted on the wiring substrate 30.

The second member 220 is placed by a molding process, such as an injection molding or transfer molding technique. A material with higher rigidity (higher Young's modulus) than the first member 210 is used for the second member 220. For example, silica-filled epoxy resin is used for the second member 220. When the second member 220 is placed, the pressure receiving member 12 may be formed integrally with the second member by insert molding (an attaching step). In this way, the force sensor 1 is manufactured.

In the force sensor 1 manufactured in this way, the first member 210 and the second member 220 constitute the pressure transmission member 10. The first member 210 serves as the first region 101, and the second member 220 adjacent to the first member 210 serves as the second region 102.

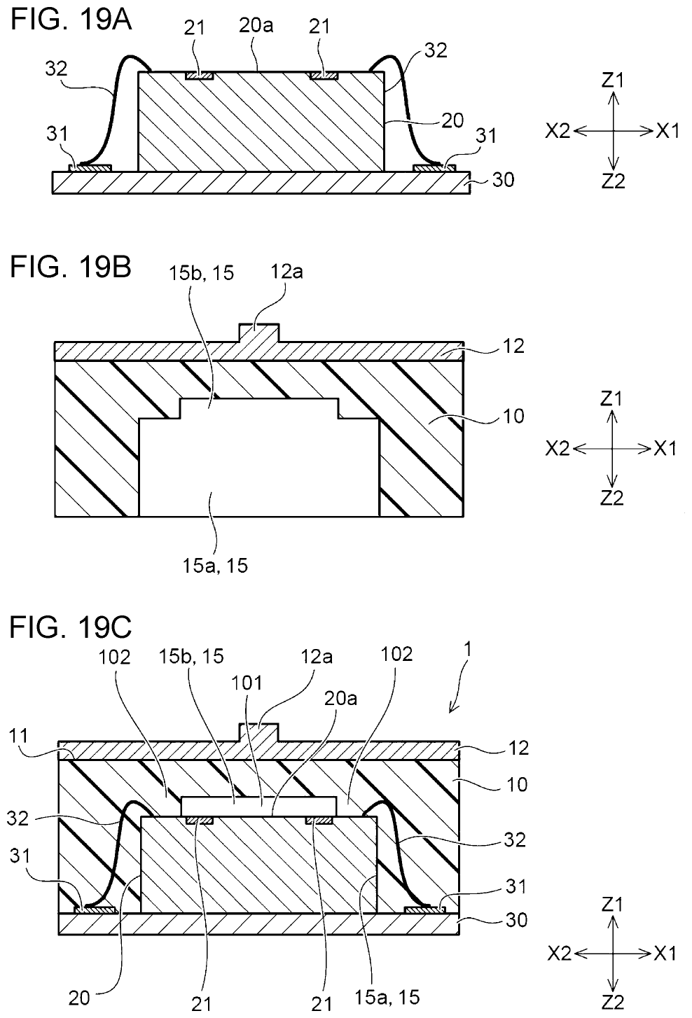

Another method for manufacturing the force sensor 1 according to the present embodiment is described below. FIGS. 19A to 19C are schematic cross-sectional views illustrating the method (a second method) for manufacturing the force sensor according to the present embodiment. As illustrated in FIG. 19A, a sensor board 20 is first formed, and the sensor board 20 is mounted on the wiring substrate 30 in the same manner as in the previously described manufacturing method (refer to FIGS. 18A and 18B). Subsequently, the bonding wire 32 is used to connect the sensor board 20 to the pad 31 of the wiring substrate 30.

Subsequently, as illustrated in FIG. 19B, the pressure transmission member 10 is prepared. For example, silica-filled epoxy resin is used for the pressure transmission member 10. The cavity 15 is formed in a substantially center portion of the pressure transmission member 10 on the Z2 side. The cavity 15 includes a first cavity portion 15a that is open on the Z2 side and a second cavity portion 15b that is provided on the Z1 side of the first cavity portion 15a and that communicates with the first cavity portion 15a. The size of the first cavity portion 15a is substantially the same as the size of the sensor board 20. As viewed in the Z1-Z2 direction, the size of the second cavity portion 15b is smaller than that of the first cavity portion 15a. The pressure receiving member 12 may be provided on the Z1 side of the pressure transmission member 10 (an attaching step).

Subsequently, as illustrated in FIG. 19C, the pressure transmission member 10 is placed on the first surface 20a of the sensor board 20 (a placing step). In the placement, the sensor board 20 is fitted into the first cavity portion 15a of the pressure transmission member 10. When the pressure transmission member 10 is placed, a clearance space for the bonding wire 32 (not illustrated) is provided in the pressure transmission member 10 to prevent the bonding wire 32 from interfering with the pressure transmission member 10.

When the sensor board 20 is placed and fixed inside of the first cavity portion 15a of the pressure transmission member 10, the second cavity portion 15b is located in the center of the first surface 20a of the sensor board 20. A portion of the pressure transmission member 10 adjacent to the second cavity portion 15b (on the Z1 side of the first cavity portion 15a) is in contact with the first surface 20a of the sensor board 20. In this way, the force sensor 1 is manufactured. When the pressure transmission member 10 and the sensor board 20 are fixed to each other using an adhesive material, the pressure transmission member 10 is in contact with the first surface 20a via the adhesive material that is cured. At this time, the cured adhesive material is regarded as part of the pressure transmission member 10, and the load applied to the protruding portion 12a is properly transmitted from the pressure transmission member 10 to the sensor board 20.

In the force sensor 1 manufactured in this way, the void part consisting of the second cavity portion 15b of the pressure transmission member 10 serves as the first region 101, and the portion of the pressure transmission member 10 that is adjacent to the second cavity portion 15b and that is in contact with the first surface 20a of the sensor board 20 serves as the second region 102.

Thus, the present embodiment can provide the force sensor 1 and the method for manufacturing the force sensor 1 with excellent load bearing property and strain gauge characteristics.

The output value (a relative value) of the full-bridge circuit with four strain gauge elements 21 included in each of the force sensor 1 and the comparative force sensor 2 according to the present embodiment were obtained by simulation.

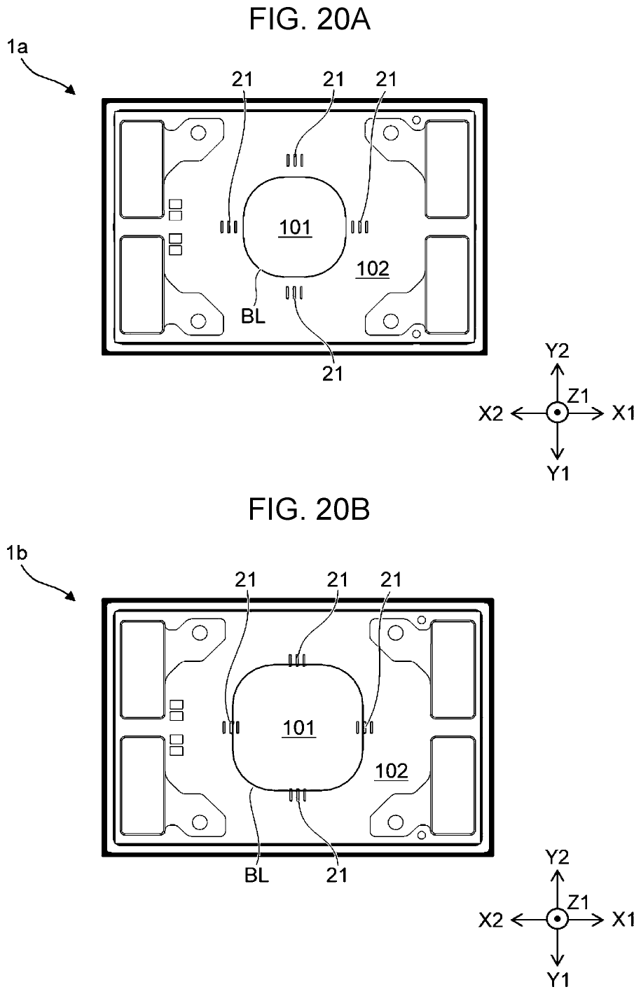

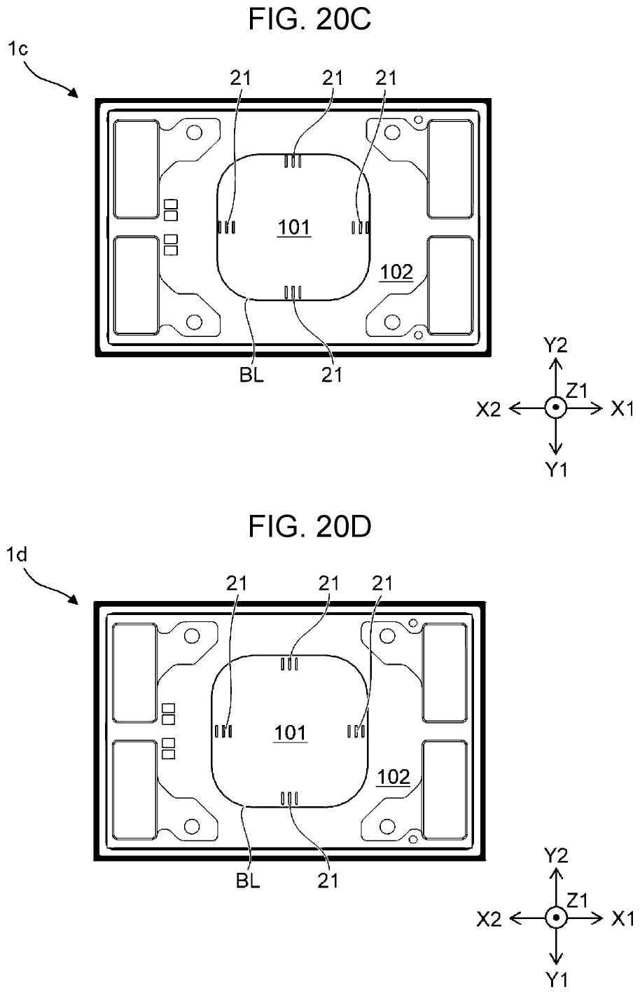

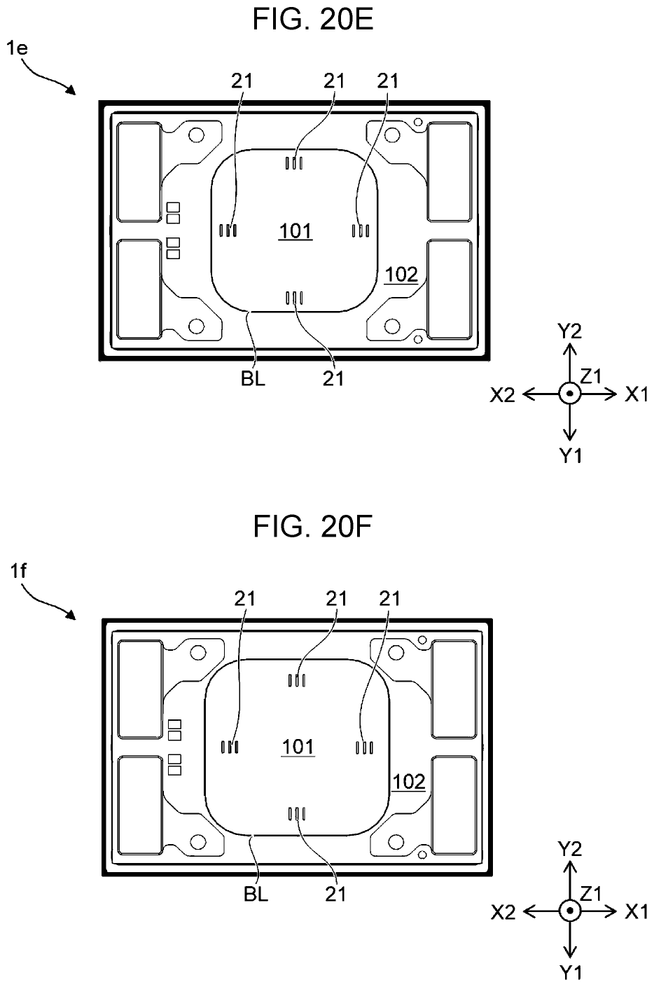

More specifically, six types of force sensors 1 (force sensors 1a to 1f) were set. The force sensors 1 had different sizes of the first region 101 as viewed in the Z1-Z2 direction and different positional relationships between a boundary BL between the first region 101 and the second region 102 and the strain gauge element 21. The force sensors 1a to 1f are illustrated in FIGS. 20A to 20F, respectively.

As illustrated in FIG. 20A, in the force sensor 1a, the strain gauge element 21 was located outside of the boundary BL (on the side adjacent to the second region 102). As illustrated in FIG. 20B, in the force sensor 1b, the strain gauge element 21 was located on the boundary BL. As illustrated in FIGS. 20C to 20F, in the force sensors 1c to 1f, the strain gauge element 21 was located inside of the boundary BL (on the side adjacent to the first region 101), and the distance between strain gauge element 21 and the boundary BL increased in the order: the force sensor 1c, the force sensor 1d, . . . , the force sensor 1f. The strain gauge elements 21 were relatively located inside of the first region 101.

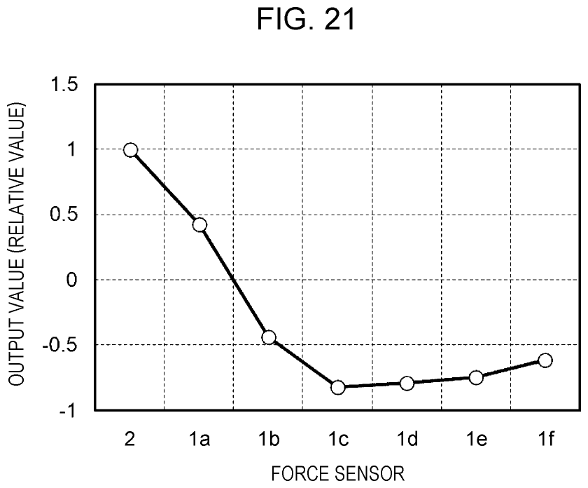

The output values obtained from the full-bridge circuit when the same load was applied to each of the force sensors 1a to 1f and the comparative force sensor 2 were relatively compared with one another, where the output value from the comparative force sensor 2 was converted to 1. The results are illustrated in TABLE 1. A graphical representation of the results illustrated in TABLE 1 is given in FIG. 21.

TABLE 1

| Force Sensor | Output Value (Relative Value) | Notes |
|---|---|---|
| 2 | 1 | Comparative example |
| 1a | 0.42 | Comparative example |
| 1b | −0.44 | Present invention |
| 1c | −0.82 | Present invention |
| 1d | −0.79 | Present invention |
| 1e | −0.74 | Present invention |
| 1f | −0.61 | Present invention |

As illustrated in TABLE 1 and FIG. 21, when the output of the comparative force sensor 2 was converted to 1, the output value of the force sensor 1a was positive in which the strain gauge element 21 did not overlap the first region 101 as viewed in the Z1-Z2 direction. However, the output values of the force sensors 1b to 1f were negative in which the strain gauge element 21 overlapped the first regions 101 as viewed in the Z1-Z2 direction. That is, in the comparative force sensor 2 and the force sensor 1a, the strain gauge element 21 was compressively deformed. However, in the force sensors 1b to 1f, the strain gauge element 21 was tensile deformed.

The comparison of the output values of the force sensors 1b to 1f, each including the strain gauge element 21 that were tensile deformed, indicated that the force sensor 1c including the strain gauge element 21 that was located closest to the boundary BL between the first region 101 and the second region 102 as viewed in the Z1-Z2 direction had the largest absolute output value, and the absolute output value decreased with increasing distance of the strain gauge element 21 from the boundary BL as viewed in the Z1-Z2 direction. The absolute output value of the force sensor 1c, which had the largest output value, was the same as that of the comparative force sensor 2.

The results presented in TABLE 1 indicates that the force sensors 1b to 1f according to the present embodiment can cause the strain gauge element 21 to deform in the tensile direction when a load is applied. As a result, the stress in the compression direction applied to the sensor board 20 can be reduced, and the load bearing property of the sensor board 20 can be improved. This can effectively prevent damage to the pressure receiving portion 11.

While the present embodiment has been described above, the present invention is not limited thereto. For example, a person skilled in the art may add or delete a constituent element to or from the above-described embodiments or change the design of the above-described embodiments or may combine the features of the example configurations of the embodiments as necessary without departing from the broad inventive concept of the present invention. Such embodiments are intended to be encompassed in the scope of the present invention.

1. A force sensor comprising:
a pressure transmission member having a pressure receiving face configured to receive a force to be detected; and
a sensor board disposed on a side of the pressure transmission member opposite from the pressure receiving face in a first direction normal to the first surface, the sensor board having a rigidity higher than that of the pressure transmission member, the sensor board including at least one strain gauge element disposed on a first surface thereof facing the pressure transmission member,
wherein the pressure transmission member includes:
a first region having a first rigidity and facing the first surface; and
a second region having a second rigidity higher than the first rigidity, the second region being provided adjacent to the first region such that an outer edge of the first region forms a boundary between the first region and the second region viewed from the first direction, the second region including a contact portion in contact with the first surface of the sensor board,
and wherein the at least one strain gauge element is disposed in a vicinity of the boundary viewed from the first direction.

2. The force sensor according to claim 1, wherein the first region is in contact with the sensor board.

3. The force sensor according to claim 1, wherein the pressure receiving face overlaps the first region and the sensor board viewed from the first direction.

4. The force sensor according to claim 1, further comprising:
a pressure receiving member having a third rigidity higher than the second rigidity, the pressure receiving member being provided on or in the pressure receiving face of the pressure transmission member.

5. The force sensor according to claim 1, wherein the pressure receiving face includes a protruding portion that protrudes therefrom in the first direction.

6. The force sensor according to claim 1, wherein the first region is formed of a material different from a material forming the second region.

7. The force sensor according to claim 1, wherein the first region is formed as an empty space facing the first surface.

8. The force sensor according to claim 1, wherein the at least one strain gauge element includes at least one piezoresistive element.

9. The force sensor according to claim 8, wherein the at least one strain gauge element is disposed so as to face the vicinity of the boundary in the first direction.

10. The force sensor according to claim 8,
wherein the at least one strain gauge element includes four piezoresistive elements forming a full-bridge circuit, the four piezoresistive elements being provided along the boundary between the first region and the second region viewed from the first direction, and
wherein the force sensor is configured to output a difference between two midpoint potentials in the full-bridge circuit as an output value thereof.

11. A method for manufacturing a force sensor including a pressure transmission member having a pressure receiving face for receiving a force to be detected, and a sensor board having a rigidity higher than that of the pressure transmission member, the method comprising:
providing at least one strain gauge element on a first surface of the sensor board;
attaching a first member having a first rigidity to the first surface, thereby providing a first region of the pressure transmission member formed by the first member, such that the at least one strain gauge element is located in a vicinity of an outer edge of the first member viewed from a first direction normal to the first surface; and
providing, a second member having a second rigidity higher than the first rigidity onto the sensor board so as to cover the first member, the second member having the pressure receiving face thereon on an opposite side from the sensor board in the first direction, thereby providing a second region of the pressure transmission member formed by the second member, the second region including a contact portion in contact with the first surface and adjacent to the first region such that the outer edge of the first region forms a boundary between the first region and the second region viewed from the first direction.

12. A method for manufacturing a force sensor including a pressure transmission member having a pressure receiving face for receiving a force to be detected, and a sensor board having a rigidity higher than that of the pressure transmission member, the method comprising:
providing at least one strain gauge element on a first surface of the sensor board;
providing the pressure transmission member having a cavity;
placing the pressure transmission member onto the sensor board such that the sensor board is accommodated in a part of the cavity while a remaining part of the cavity provides a first region of the pressure transmission member having a first rigidity and facing the first surface, the remaining pressure transmission member forming and a second region of the pressure transmission member having a second rigidity higher than the first rigidity, the second region being adjacent to the first region and having a contact portion in contact with the first surface such that a boundary between the first region and the second region is formed on the first surface viewed from the first direction,
wherein the pressure transmission member is placed such that the at least one strain gauge element is disposed in a vicinity of the boundary viewed from the first direction.

13. The method according to claim 11, wherein the providing the second member includes a molding process.

14. The method according to claim 13, wherein the molding process includes:
placing a pressure receiving member having a third rigidity higher than the second rigidity to face the first surface of the sensor board with a certain distance therefrom; and
injecting a material containing a resin between the pressure receiving member and the sensor board, thereby insert molding the second member with the pressure receiving member.

15. The method according to claim 11, further comprising:
attaching a pressure receiving member having a third rigidity higher than the second rigidity to the pressure transmission member so as to overlap the pressure receiving face viewed from the first direction.

16. The method according to claim 12, further comprising:
attaching a pressure receiving member having a third rigidity higher than the second rigidity to the pressure transmission member so as to overlap the pressure receiving face viewed from the first direction.

17. The method according to claim 11, wherein the providing at least one strain gauge element includes:
providing four piezoresistive elements forming a full-bridge circuit, such that the four piezoresistive elements are disposed along the boundary between the first region and the second region viewed from the first direction.

18. The method according to claim 12, wherein the providing at least one strain gauge element includes:
providing four piezoresistive elements forming a full-bridge circuit, such that the four piezoresistive elements are disposed along the boundary between the first region and the second region viewed from the first direction.

19. The method according to claim 12,
wherein the cavity of the pressure transmission member includes:
a first cavity portion for receiving the sensor board; and
a second cavity portion smaller than the first portion and in communication with the first portion,
and wherein the placing the pressure transmission member includes:
accommodating the sensor board in the first cavity portion such that the second cavity portion provides an empty space facing the first surface, thereby forming the first region of the pressure transmission member.
